(19) United States
(12) Patent Application Publication
(10) Pub. No.: US 2012/0181092 A1
(43) Pub. Date: Jul. 19, 2012

(54) SYSTEM FOR INSPECTING AND WEIGHTING OBJECTS, PARTICULARLY PREFORMS

(75) Inventors: Cristian Scalini, Imola (BO) (IT); Walter Tontini, Imola (BO) (IT)

(73) Assignee: Sacmi Cooperative Meccanici Imola Societa' Cooperativa, Imola (IT)

(21) Appl. No.: 13/349,113

(22) Filed: Jan. 12, 2012

Related U.S. Application Data
(63) Continuation of application No. PCT/IT2010/000276, filed on Jun. 22, 2010.

(30) Foreign Application Priority Data
Jul. 17, 2009 (IT) RM2009A000377

(51) Int. Cl. G01G 19/52

(52) U.S. Cl. 177/50

(57) ABSTRACT

The present invention relates to a System for automatic evaluation of preforms, characterized in that it provides an inspection system, to which preforms are supplied, a weighting system, downward the inspection system, and a selection system, downward the weighting system, said preforms being transferred from the inspection system to the weighting system with a set orientation.

The present invention relates to a system for inspecting and weighting objects, particularly preforms.

More specifically, the invention concerns a system of the above kind permitting carrying out both operations of objects having a substantially elongated shape, and preferably on preforms, said objects being advanced along manufacturing lines.

In the following the specification will be specifically addressed to working of preforms, but, as already said, the same technical teachings can be applied on different objects.

As it is well known, a relevant role in manufacturing lines is played by possibility of inspecting products, and particularly preforms, i.e. those artefacts made up of PET (polyethylene) that, by a subsequent suitable operation process, are suitable to be transformed into PET containers, such as bottles, ensuring the highest reliability, without slowing the manufacturing.

Systems exist for inspecting preforms, said systems being substantially comprised of a supply device supplying preforms to a tunnel, from which they are brought along a path, in correspondence of which different cameras are provided, said camera acquiring different images of preforms.

Inspection is carried out on a sample of products along the manufacturing system.

Usually, a selection device is provided at the exit of the inspection system, said device separating “good” preforms, which are sent beyond for further working steps, from those to be discarded.

A weighting operation is sometimes carried out after the inspection.

At present, said weighting is manually carried out in the laboratory.

In this situation, it is well evident the advantage of having a system as the one suggested according to the present invention, permitting automatically carrying out the operation on sample subjected to inspection, preferably in a higher number of samples than known systems, by specialised labour.

In this context, the Applicant suggest, according to the present invention, introducing a weighting system, between the inspection system and the selection device, being it possible carrying out automatically both inspection and weighting operations.

It is therefore specific object of the present invention a system for automatic evaluation of preforms, characterized in that it provides an inspection system, to which preforms are supplied, a weighting system, downward the inspection system, and a selection system, downward the weighting system, said preforms being transferred from the inspection system to the weighting system with a set orientation.

According to the invention, said inspection system provides a supply system and a tunnel, along which preforms advance following a path in correspondence of which cameras for observing preforms are provided.

Always according to the invention, transfer of preforms from inspection system to the weighting system is realized by a channel comprised of plastic material cannulae, particularly eight cannulae.

Still according to the invention, a support is provided downward the system for transferring preforms, substantially an elongated V shaped support, having an inner groove on correspondence of V vertex, permitting contacting perform tip and stabilizing its oscillations due to the fall impact, preform resting within said groove, terminating passage from a substantially vertical position to a substantially horizontal position.

Preferably, according to the invention, said guide is comprised of crystalline polymeric material, preferably an acetalic resin, and particularly polyoxymethylene or POM-C, and it is coated with nitrilic rubber or anti-oil strips.

Furthermore, according to the invention, at the end of said guide, it is provided a stop system or blades, rotating according to the preform advancement direction within the weighting system, along a belt, to stop preform arriving from the guide and, after weighting, supplying it to the selection system.

Still according to the invention, said weighting system provides a load cell on masse, particularly masse weighting 60 kg, resting on anti-vibration elements, so as to eliminate all low frequency vibrations.

Furthermore, according to the invention, said preform selection system is of the pneumatic type.

The present invention will be now described, for illustrative, but not limitative purposes, according to its preferred embodiments, with particular reference to the figures of the enclosed drawings, wherein:

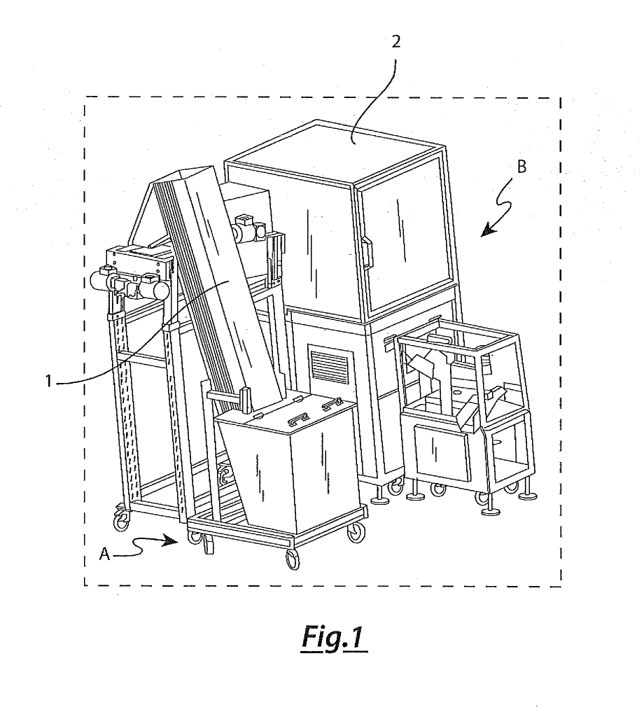

FIG. 1 is a perspective view of an inspection and weighting system according to the invention;

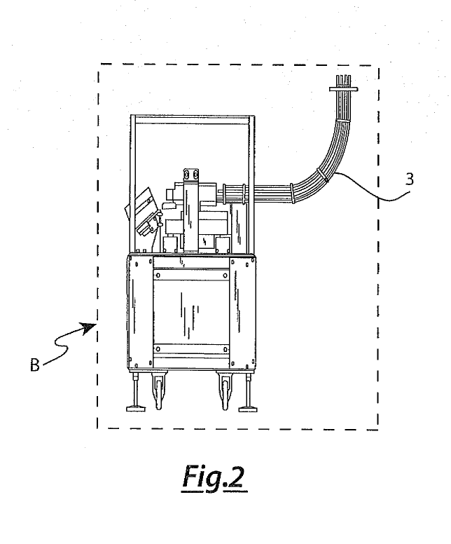

FIG. 2 is a lateral view of the weighting portion of the system according to the invention;

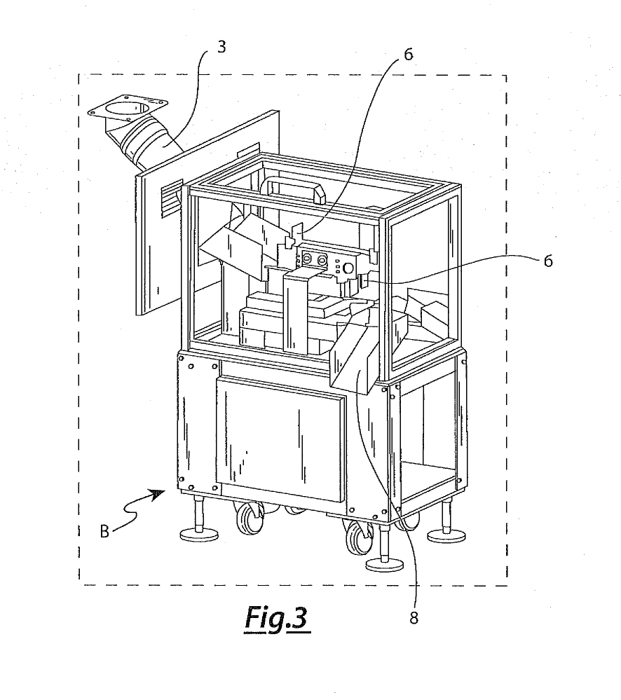

FIG. 3 is a total perspective view of the weighting portion of the system according to the invention;

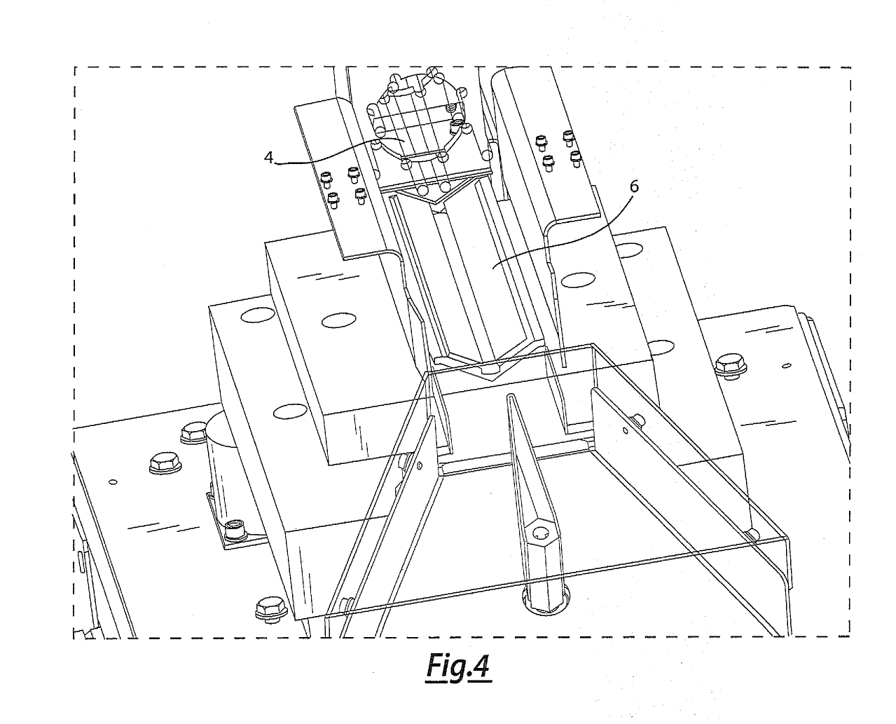

FIG. 4 shows a first particular of the weighting portion of the system according to the invention;

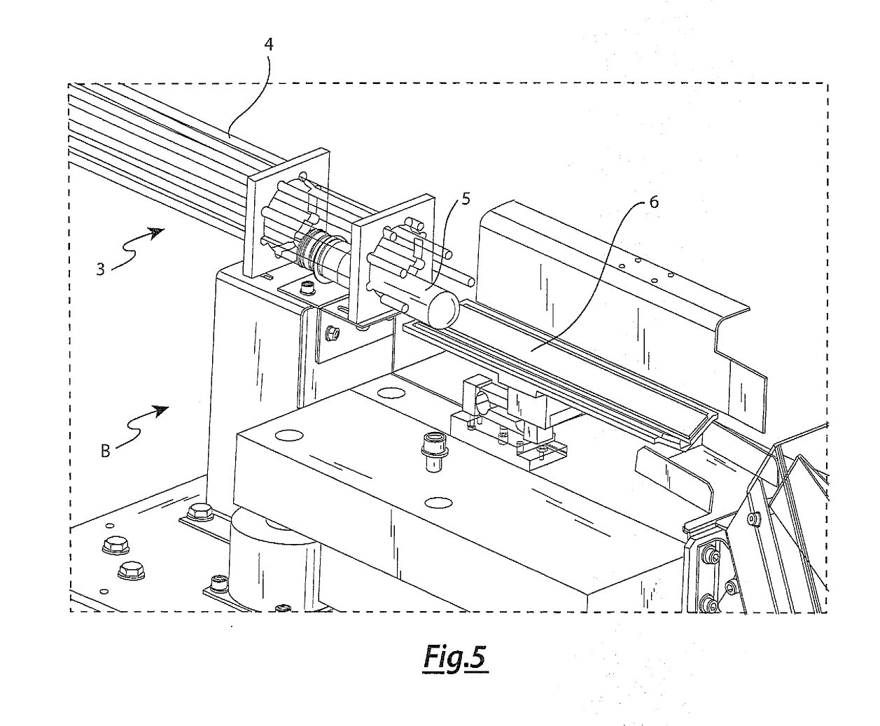

FIG. 5 shows a second particular of the weighting portion of the system according to the invention;

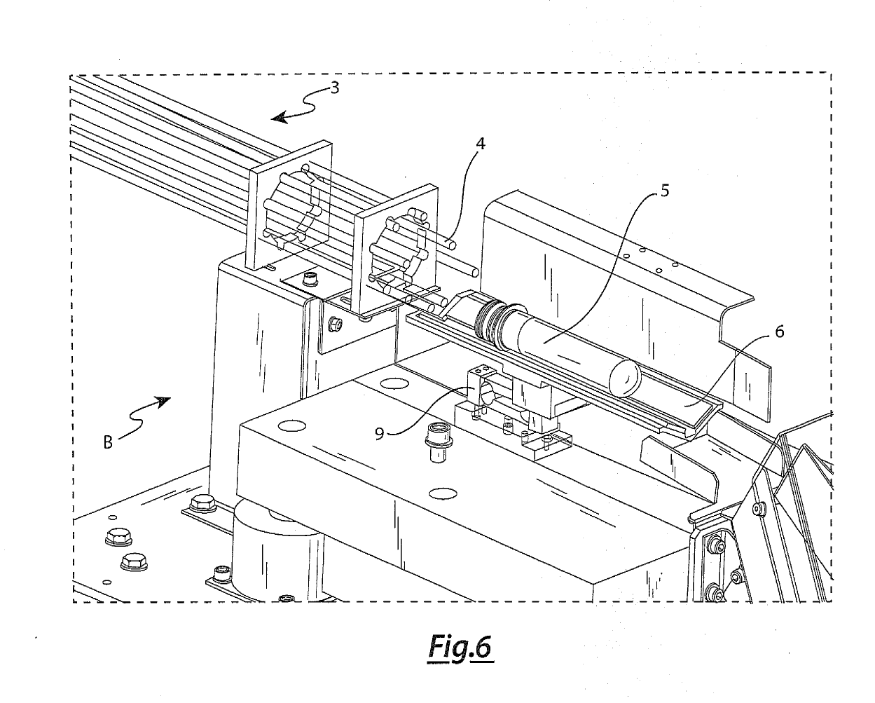

FIG. 6 shows the second particular of the weighting portion of the system according to the invention in a second working step;

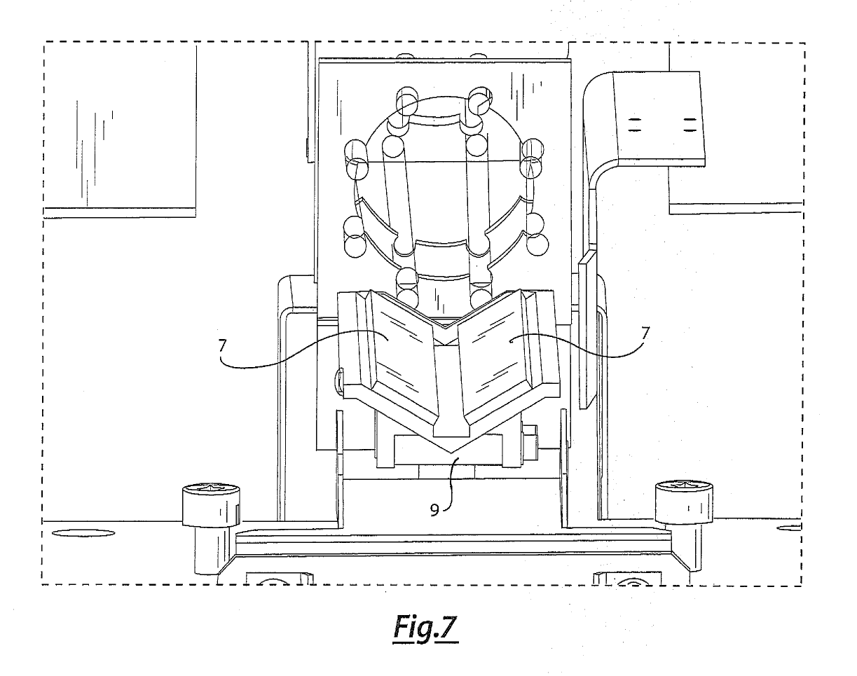

FIG. 7 is a front view of particular of FIG. 5;

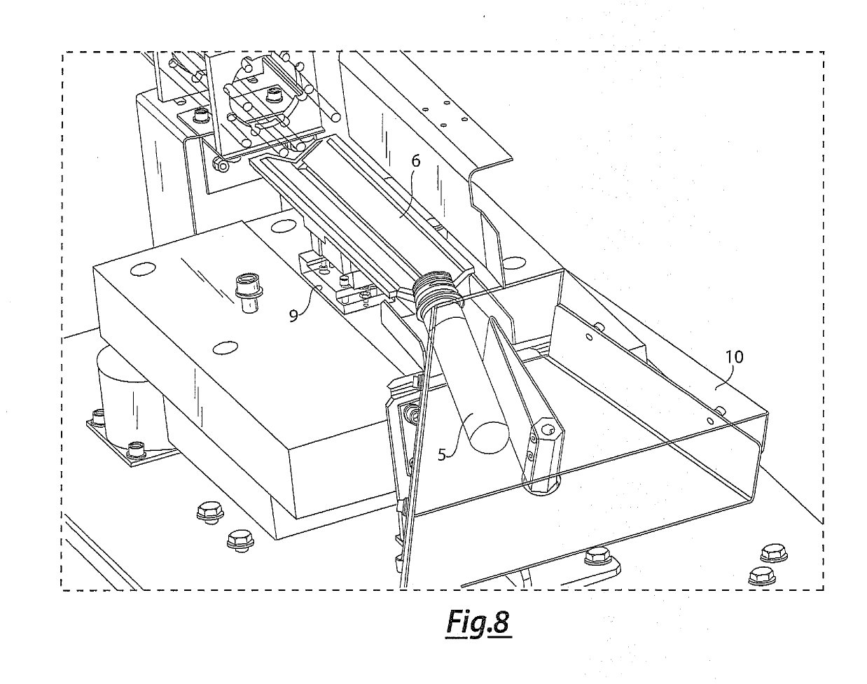

FIG. 8 is a perspective view of a further particular of the system according to the invention; and

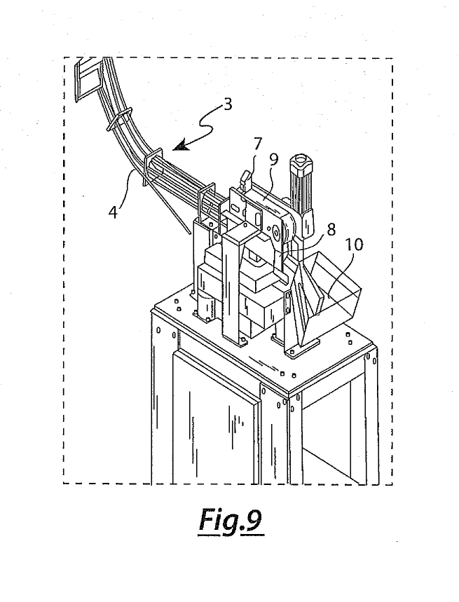

FIG. 9 is a top perspective view of the weighting portion of the system according to the invention.

Observing first FIG. 1, it is shown a system according to the invention, providing a preform inspection portion A and a preform weighting portion B, before selection of the “good” preforms with respect to those to be discharged.

Inspection system A, that will be not described particularly, since it can be realised by known solutions, provides a supply device 1, supplying preforms (not shown in this figure) to a tunnel 2, within which preforms advance along a path, in correspondence of which cameras (not shown) are provided, said cameras acquiring images of the different parts of preforms.

At the exit of inspection system A, it is provided a channel 3 (see FIG. 2), comprised of a plastic material channel 4 (that can be well seen from FIGS. 5-8), transferring preform toward weighting system B. Preform of FIGS. 5-8 is indicated by reference number 5.

Particularly, two lower cannulae 4 permit to preforms having a constant inlet position on guide 6.

At the inlet of the weighting system B (FIG. 4), preforms 5, arrived through channel 3, is received on a substantially V-shaped support 6, developing in length, and provided with an inner groove, in correspondence of the support 6 V apex, permitting realising a contact with preform 5 tip and stabilizing oscillations of the same due to the impact caused by falling (see FIGS. 5 and 6).

Said support 6 is comprised of a crystalline polymer, particularly polyoxymethylene or POM-C, material selected for its capability of quickly dampening oscillations of preform 5 hitting on support 6 at the inlet of the weighting system B.

Polyoxymethylene or POM-C, which is an acetalic resin, is a crystalline polymer, discovered during the '60, obtained by polymerisation of formaldehyde. It can be of the copolymer (C) or homopolimer (H) type; first one is more resistant to hydrolysis, to thermo-oxidising degradation, and strong alkali, while the second one has a better rigidity, a better creep resistance and better mechanical properties; furthermore, it has a better thermal dilatation coefficient. Said material is well suitable to working with automatic lathe and it is advisable for realising precision particulars.

Further, support 6 is coated with anti-oil strips 7 permitting a more efficient stabilisation of preform. It is a nitrilic rubber, resistant to, animal and vegetal, mineral oils and fats, with good mechanical properties under temperature up to 100° C.

A pair of palette 8 is provided at the end of preform path along V-shaped support, on a rotating belt, following preform 5 during weighting phase up to its discharging.

Blade 8 and rubber strips 7 make preform bouncing following the hit against blades 8, always in a set a reproducible point/position, permitting a reproduction reliability of weighting operations.

In correspondence of the preform 5 bouncing position on blade 8, a known load cell 9 is provided, measuring preform weight.

Load cell 9 is mounted over 90 kg masses resting on antivibration elements, so as to eliminate all low frequency vibrations that could alter measurements.

Preform 5 is conveyed outside the weighting system B by palette 8, one of which, rotating, pushes preform outward, toward a selector 10, that can pass from a discharging position to a preform choice position, particularly by pneumatic pistons.

The present invention has been described for illustrative but not limitative purposes, but it is to be understood that variations and/or modifications can be introduced by those skilled in the art without departing from the relevant scope, as defined in the enclosed claims.

1. System for automatic evaluation of preforms, said system providing an inspection system, to which preforms are supplied, a weighting system, downward the inspection system, and a selection system, downward the weighting system, said preforms being transferred from the inspection system to the weighting system with a set orientation, said system being characterized in that a support is provided downward the system for transferring performs, substantially an elongated V shaped support, having an inner groove on correspondence of V vertex, permitting contacting perform tip and stabilizing its oscillations due to the fall impact, preform resting within said groove, terminating passage from a substantially vertical position to a substantially horizontal position.

2. System according to claim 1, characterized in that said inspection system provides a supply system and a tunnel, along which preforms advance following a path in correspondence of which cameras for observing preforms are provided.

3. System according to claim 1, characterized in that transfer of preforms from inspection system to the weighting system is realized by a channel comprised of plastic material cannulae.

4. System according to claim 3, characterized in that said channel provides eight cannulae.

5. (canceled)

6. System according to claim 1, characterized in that said guide is comprised of crystalline polymeric material, preferably an acetalic resin, and particularly polyoxymethylene or POM-C, and it is coated with nitrilic rubber or anti-oil strips.

7. System according to one of the preceding claims claim 1, characterized in that, at the end of said guide, it is provided a stop system or blades, rotating according to the preform advancement direction within the weighting system, along a belt, to stop preform arriving from the guide and, after weighting, supplying it to the selection system.

8. System according to claim 1, characterized in that said weighting system provides a load cell on masse, particularly masse weighting 60 kg, resting on anti-vibration elements, so as to eliminate all low frequency vibrations.

9. System according to claim 1, characterized in that said preform selection system is of the pneumatic type.
